(19) United States
(12) Patent Application Publication
(10) Pub. No.: US 2022/0211086 A1
(43) Pub. Date: Jul. 7, 2022

(54) FROZEN FOOD PRODUCT

(71) Applicant: Ramen Marketing Corp., Toronto (CA)

(72) Inventor: Hiroshi YOSHIDA, North York (CA)

(21) Appl. No.: 17/318,410

(22) Filed: May 12, 2021

Related U.S. Application Data
(60) Provisional application No. 63/134,486, filed on Jan. 6, 2021.

(51) Int. Cl. A23L 23/10; A23L 7/113; A23L 5/10

(52) U.S. Cl. CPC A23L 23/10; A23L 5/11; A23L 7/113

(57) ABSTRACT

A frozen food product comprising a first food product portion, a second food product portion and a third food product portion is disclosed. The first food product portion, a second food product portion and a third food product portion are configured such that the second food product portion is disposed intermediate the first food product portion and the third food product portion. In some embodiments, the frozen food product is frozen Ramen wherein the first food product portion is frozen soup broth, the second food product portion is a frozen noodle mass, and the third food product portion includes at least one or more toppings commonly found in Ramen. In some embodiments, the third food product portion is a composite layer that includes one or more toppings commonly found in Ramen that are embedded within frozen soup broth.

### CROSS-REFERENCE TO RELATED APPLICATION(S)

This application claims the benefit of and priority to U.S. Provisional Patent Application No. 63/134,486 filed Jan. 6, 2021 under the title FROZEN FOOD PRODUCT, the content of which is hereby expressly incorporated by reference into the detailed description hereof.

### FIELD

The present disclosure relates to a frozen food product. More specifically, the present disclosure relates to frozen soup products, in particular frozen Ramen.

### BACKGROUND

Ramen is known as a Japanese delicacy. Traditional Ramen contains soup broth, noodles and various toppings that often include vegetables and meat and/or other proteins as well as additional fresh herbs and/or seasonings. Ramen is best served fresh to ensure that the noodles and the various toppings included in the soup are each cooked to the preferred or desired consistency to achieve a quality Ramen product.

Ramen that is prepared and cooked fresh at a restaurant and then delivered to a customer via a takeout or delivery service is known to be less enjoyable as compared to when the soup is enjoyed fresh. The delay between the preparation of the Ramen and the actual consumption of the Ramen product, due to the delivery time, has been found to deteriorate the overall quality of the Ramen. In particular, the taste and texture of the noodles and the taste and texture of the individual toppings often deteriorates between the time the soup is prepared and the time that the soup is consumed. The deterioration in the taste and texture of the noodles and the individual toppings can be attributed, in some instances, to additional cooking of the noodles and the toppings that occurs within the closed delivery container, beyond the recommended cooking time, due to the temperature of the hot soup. While sitting in the closed delivery container, the noodles tend to become softer in texture and sometimes absorb additional liquid from the soup broth, which not only deteriorates the texture of the noodles but can also have an effect on the taste and colour and/or overall visual appearance of the noodles. The toppings can also deteriorate while the soup is stored in the delivery container as the vegetables, herbs and other fresh seasonings can also become overcooked while submerged in the hot broth and may wilt due to the steam and condensation within the closed delivery container altering the texture, taste and visual appearance of the vegetables, herbs and other fresh seasonings. Meat and proteins have also been found to absorb moisture from the liquid soup broth which can affect the taste and texture of the meat or protein. The overall taste and quality of the soup broth has also been found to deteriorate over time, in some instances, as a result of the noodles and various toppings being submerged within the soup broth for an extended period time between the time that the soup is prepared and the time that the soup is actually consumed, which can alter the overall flavour of the soup. While separating the noodles and toppings from the broth is one technique that can be employed in order to maintain the quality and taste of the ingredients, this has also been found to result in a less desirable product as it requires re-heating of various components of the soup, is more labour intensive, and does not always result in a quality product with the noodles and toppings being cooked to the desired “doneness” or texture.

In order to address the need for easy and convenient methods to prepare and enjoy Ramen at home, instant versions of Ramen-style products are known wherein the noodles and the toppings are dehydrated or freeze-dried (or otherwise preserved according to known techniques) and provided to the customer in a package along with a separate package of concentrated soup. The concentrated soup is added to boiling or hot water along with the noodles and dehydrated toppings in order to re-hydrate the dried ingredients and complete the cooking/re-heating process. While instant versions of Ramen may be convenient and easy to prepare, the dehydrated noodle and concentrated soup versions often have high concentrations of sodium, additional preservatives and do not compare to fresh, restaurant quality Ramen.

Frozen versions of Ramen products are also known wherein the soup broth and additional ingredients (e.g. the noodles and toppings) are frozen and packaged separately and intended for re-heating in a microwave oven. Some versions are known wherein the frozen soup is contained in a first container while the noodles and other ingredients or toppings are contained in a second container with the second container being stacked within the first container. The container is suitable for re-heating within a microwave oven and once the frozen soup broth has been thawed and heated in the microwave, the noodles and toppings can be dropped into the liquid broth with the second container serving as a lid to complete the re-heating process. With the increasing trend towards greener products with less environmental impact, the additional packaging associated with these styles of products is undesirable.

Therefore, improved products that allow for restaurant quality or superior tasting Ramen to be easily and conveniently enjoyed at home are desirable. Additionally, improved products that allow for restaurant quality or superior tasting Ramen to be easily and conveniently enjoyed at home and that offer reduced packaging and reduced environmental impact, are also desirable.

### SUMMARY

According to one aspect of the present disclosure there is provided a frozen food product, comprising a first food product portion; a second food product portion; and a third food product portion wherein: the first food product portion is frozen soup broth; the second food product portion is a frozen noodle mass; and the third food product portion includes at least one or more individual frozen food items; and the first food product portion, the second food product portion and the third food product portion are cooperatively configured such that: the first food product portion, the second food product portion and the third food product portion are a frozen unit; and the second food product portion is disposed intermediate the first food product portion and the third food product portion.

According to another aspect of the present disclosure there is provided a frozen food product, comprising: a first frozen food portion defining a first surface and second, food product-defining surface that is disposed opposite to the first surface; a second frozen food portion defining a first surface and a second food product-defining surface, disposed opposite to the first surface; and a third frozen food portion; wherein: the second frozen food portion includes a cavity region that extends into the second frozen food portion from the second, food product-defining surface; the third frozen food portion includes one or more individual frozen food items; and the first frozen food portion, the second frozen food portion and the third frozen food portion are cooperatively configured such that: the second frozen food portion is disposed intermediate the first frozen food and the third frozen food portion; and the third frozen food portion is disposed on the second frozen food portion such that at least one of the one or more individual frozen food items is disposed within the cavity region.

According to another aspect of the present disclosure there is provided a frozen food product, comprising: a first food product portion; a second food product portion; and a third food product portion; wherein: the first food product portion, the second food product portion and the third food product portion are cooperatively configured such that: the second food product portion is disposed intermediate the first food product portion and the third food product portion; and the first food product portion is a first portion of frozen soup broth; the second food product portion is a frozen noodle mass; and the third food product portion includes a second portion of frozen soup broth and a plurality of frozen food items embedded within the frozen soup broth.

According to another aspect of the present disclosure there is provided a method of making a frozen food product comprising the steps of: freezing a portion of soup broth within a mold such that a first food product portion is formed within the mold; preparing a batch of partially cooked noodles, wherein the partially cooked noodles are boiled for a minimum of ⅙^{th} to a maximum of ⅕^{th} of a predetermined cooking time; coating the partially cooked noodles with oil such that a portion of oil-coated, partially-cooked noodles is formed; disposing the portion of oil-coated, partially-cooked noodles on the first food product portion within the mold; preparing a portion of toppings wherein each of the toppings, independently, is either partially cooked or fully cooked; disposing the portion of toppings on the oil-coated, partially-cooked noodles within the mold; freezing the portion of oil-coated, partially-cooked noodles and the portion of toppings such that a second food product portion and a third food product portion are formed.

According to another aspect of the present disclosure there is provided a method of making a frozen food product comprising the steps of: freezing a portion of soup broth within a container that is suitable for use within a microwave such that the first food product portion is formed within the container; preparing a batch of partially cooked noodles, wherein the partially cooked noodles are boiled for a minimum of ⅙^{th} to a maximum of ⅕^{th} of a predetermined cooking time; coating the partially cooked noodles with oil such that a portion of oil-coated, partially-cooked noodles is formed; disposing the portion of oil-coated, partially-cooked noodles on the first food product portion within the container; freezing the portion of oil-coated, partially-cooked noodles on the first food product portion such that the second food product portion is formed; combining a portion of toppings with a second portion soup broth; freezing the portion of toppings with the second portion soup broth in a mold such that the third food product portion is formed; and removing the third food product portion from the mold and disposing the third food product portion on the second food product portion within the container.

### BRIEF DESCRIPTION OF THE DRAWINGS

Reference will now be made, by way of example, to the accompanying drawings which show example embodiments of food product as disclosed in the present application, and in which:

FIG. 1 is a photographic representation of a frozen food product according to an example embodiment of the present disclosure;

FIG. 2 is a perspective view of a schematic representation of the frozen food product of FIG. 1;

FIG. 3 is a top plan view of the schematic representation of the frozen food product of FIG. 2;

FIG. 4 is a side elevation view of the schematic representation of the frozen food product of FIG. 2;

FIG. 5 is a cross-sectional view of the frozen food product of FIG. 2 taken along section line 5-5;

FIG. 6A is a schematic flow diagram illustrating the freezing process steps in the manufacture of a frozen food product according to an example embodiment of the present disclosure;

FIG. 6B is a schematic flow diagram further illustrating the freezing process steps in the manufacture of a frozen food product of FIG. 6B;

FIG. 6C is a schematic representation of a further process step in the freezing process of the manufacture of a frozen food product according to an example embodiment of the present disclosure.

FIG. 7 is a perspective view of a schematic representation of a frozen food product according to another example embodiment of the present disclosure that is suitable for re-heating in a microwave oven;

FIG. 8 is a top plan view of the schematic representation of the frozen food product of FIG. 7;

FIG. 9 is a cross-sectional view of the frozen food product of FIG. 8 taken along section line 10-10;

FIG. 10 is a schematic flow diagram illustrating the freezing process steps in the manufacture of the frozen food product of FIG. 7;

FIG. 11 is a cross-sectional view of a frozen food product according to another example embodiment of the present disclosure;

FIG. 12A is a table of example toppings and other ingredients that may be included in the frozen food product;

FIG. 12B is a table of example ingredients that may be included in the frozen noodle mass of the frozen food product as well as example ingredients that may be included in the soup broth of the frozen food product;

FIG. 12C is a table that includes further example ingredients that may be included in the soup broth and in the overall frozen food product.

Similar reference numerals may have been used in different figures to denote similar components.

### DESCRIPTION OF EXAMPLE EMBODIMENTS

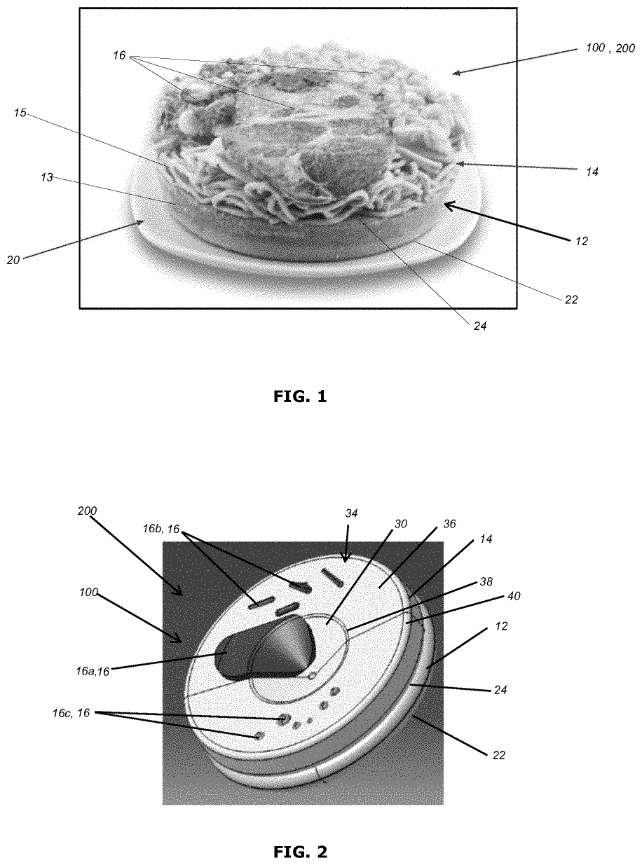

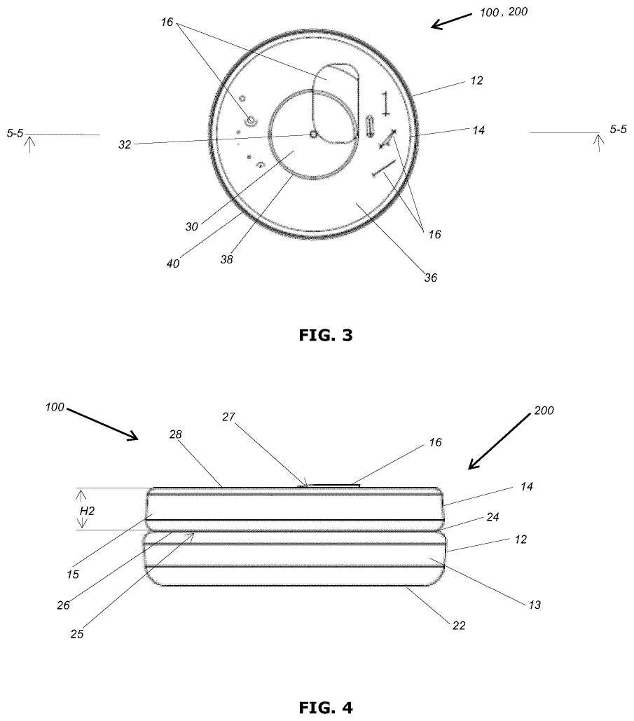

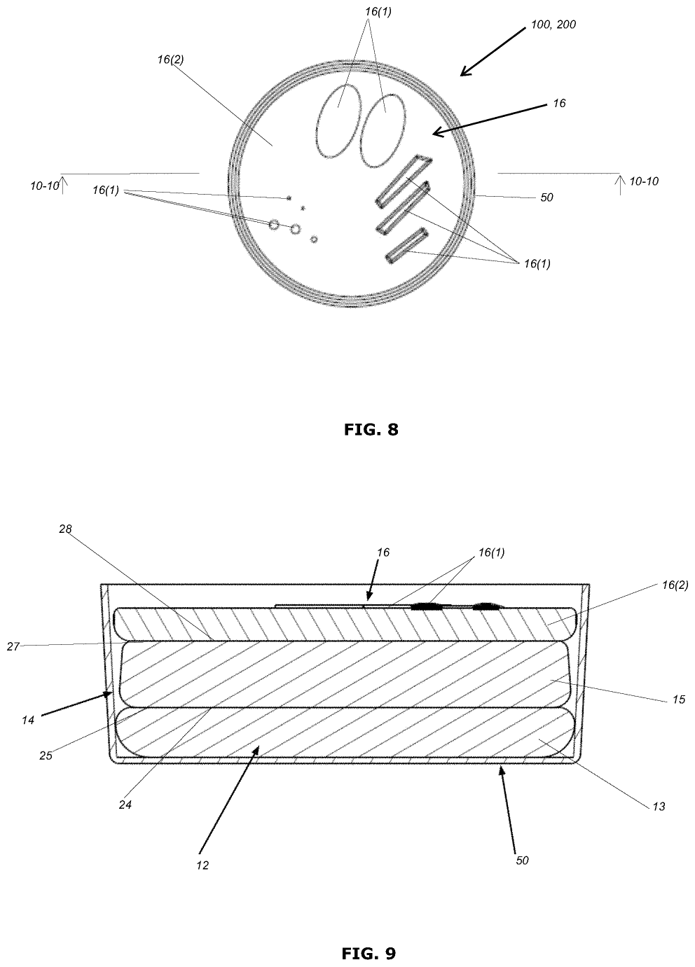

With reference now to FIGS. 1-11, there are shown example embodiments of a food product 100 according to the present disclosure. The food product 100 has a frozen state 200 and a re-heated state (not shown). While the food product 100 is disposed in the frozen state 200, the food product 100 is a frozen food product that is suitable for storage within a freezer. While the food product 100 is disposed in the frozen state 200, the food product 100 maintains the freshness of the ingredients that make-up the food product 100. While the food product 100 is disposed in the re-heated state (not shown), the food product 100 is disposed in a condition wherein the food product 100 is suitable for consumption.

In some embodiments, for example, while the food product 100 is disposed in the frozen state 200, the food product 100 is configured for reheating, via conduction, using any suitable cookware component on a conventional heat source, for example, a stove-top. However, it will be understood that any suitable heat source may be used for re-heating the product 100, via conduction, while the food product 100 is disposed in a suitable cookware component, such that the food product 100 transitions from the frozen state 200 to the re-heated state. In other embodiments, for example, while the food product 100 is disposed in the frozen state 200, the food product 100 is configured such that it is particularly suited for re-heating via radiation, for example, in a microwave oven, or other equivalent device.

In some embodiments, for example, the food product 100 is a soup product such that while the food product 100 is disposed in the frozen state 200, the food product 100 is a frozen soup product. In some embodiments, for example, the food product 100 is a Ramen product such that while the food product 100 is disposed in the frozen state 200, the food product 100 is a frozen Ramen product that may be stored within a freezer unit and re-heated at a later date.

With reference to the example embodiments illustrated in FIGS. 1-10, in some embodiments, for example, while the food product 100 is disposed in the frozen state 200, the food product 100 has a stacked or layered configuration. More specifically, in some embodiments, for example, while the food product 100 is disposed in the frozen state 200, the food product 100 includes a first food product portion 12, a second food product portion 14, and a third food product portion 16, wherein the first food product portion 12, the second food product portion 14 and the third food product portion 16 are co-operatively configured such that the second food product portion 14 is disposed intermediate the first food product portion 12 and the third food product portion 16.

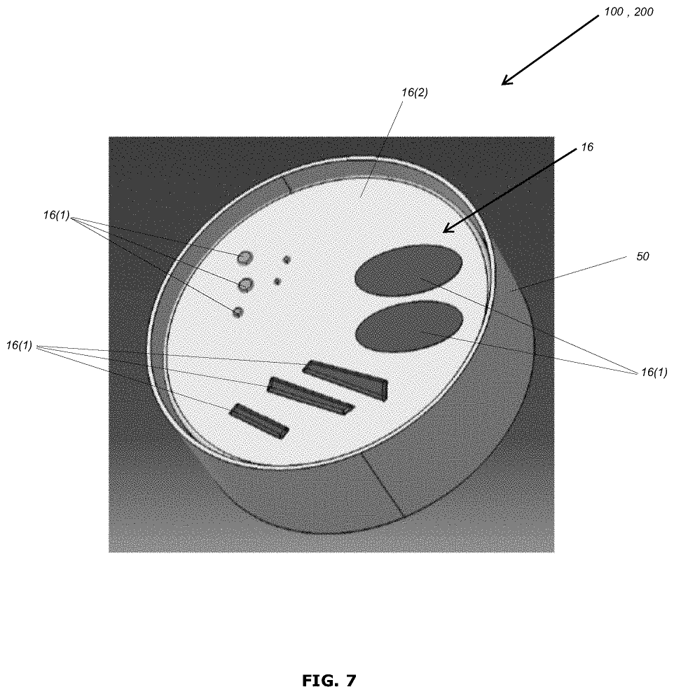

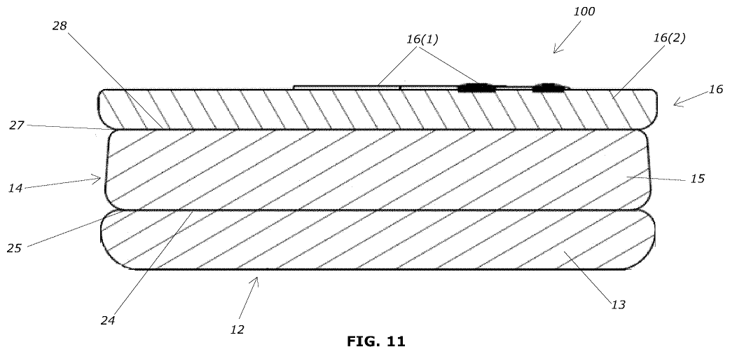

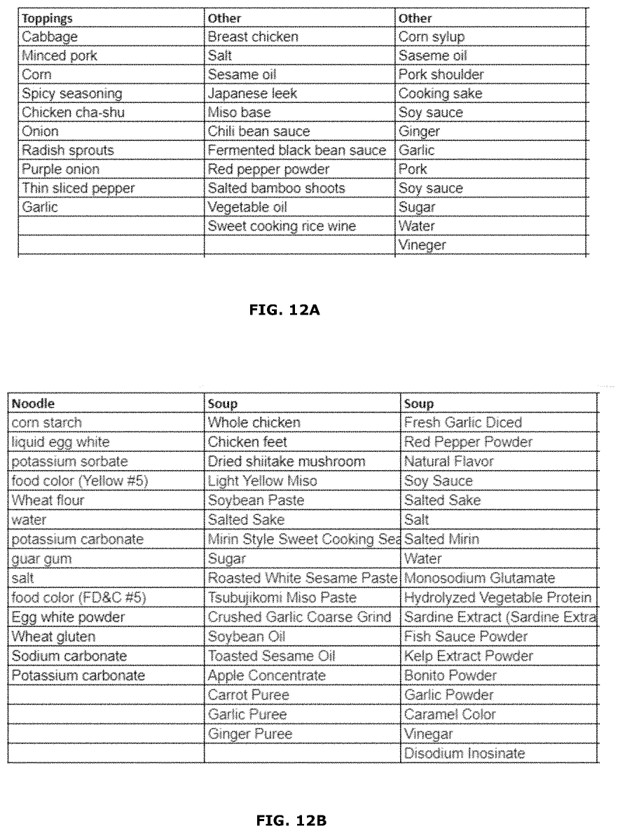

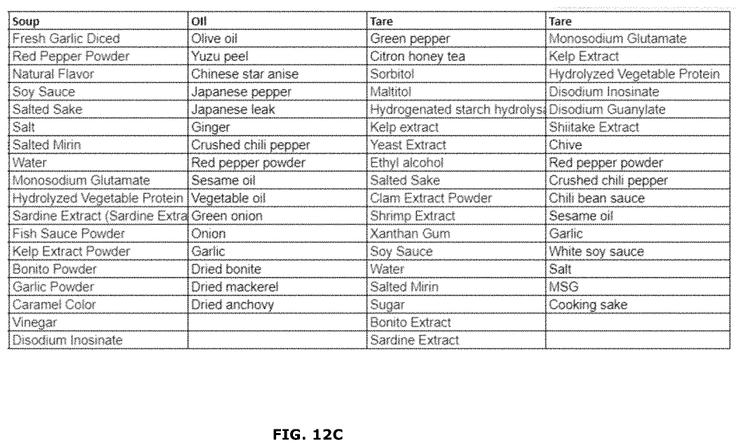

As described above, in some embodiments, for example, the food product 100 is a frozen soup product. Therefore, in some embodiments, for example, the first food product portion 12 is frozen soup broth, while the second food product portion 14 includes a frozen noodle mass. In some embodiments, for example, the third food product portion 16 includes at least one or more frozen toppings or ingredients, wherein the frozen toppings or ingredients include one or more of the following alternatives: meat (for example beef, chicken, pork and seafood), vegetable-based protein sources (for example, tofu, Beyond Meat), vegetables, fungi, herbs, and seasonings. In instances where the food product 100 is frozen Ramen, the third food product portion includes at least one or more frozen ingredients that are commonly found as toppings or food product ingredients found within the Ramen. In some embodiments, for example, the third food product portion 16 is a frozen layer that includes one or more frozen ingredients 16(1) that are encased within frozen soup broth 16(2), as will be described in further detail below in connection with the example embodiment illustrated in FIG. 11 and the example embodiment of FIGS. 7-10.

Referring in particular to the example embodiment illustrated in FIGS. 1-6, there is shown an example embodiment of a food product 100 according to the present disclosure wherein the food product 100 is configured such that, while the food product 100 is disposed in the frozen state 200, the food product 100 is configured for re-heating, via conduction. More specifically, in the subject example embodiment, the food product 100 is configured for re-heating in any suitable cookware component that can be used on any corresponding suitable heat source, such as a stove-top, hot plate, induction cooktop, etc. Accordingly, in the subject example embodiment, heat from the heat source is transferred to the food product, via conduction, through the cookware component due to the contact between the food product 100 and the cookware component thereby allowing the frozen food product 100 to thaw and defrost from the frozen state 200 and be re-heated, thereby completing the cooking process until the food product 100 is in a condition suitable for consumption. Accordingly, in the subject example embodiment, the food product 100 is intended to be provided to the user in the frozen state 200 in a removable outer package or wrapping (not shown). While the food product 100 is disposed in the frozen state 200 and is sealed within the removable outer package or wrapping, the food product 100 is suitable for storage within a freezer until the product is ready for use. Once the food product 100 is ready for use, the outer package or wrapping is removed and the frozen food product 100 is emplaced within any suitable cookware component, as a solid frozen unit, in a heat-receiving orientation 20 so that the product can be re-heated and enjoyed, via a single step re-heating process, as will be described in further detail below.

While the food product 100 is disposed in the frozen state 200, the first food product portion 12, the second food product portion 14, and the third food product portion 16 are co-operatively configured such that the second food product portion 14 is disposed intermediate the first food product portion 12 and the third food product portion 16. Therefore, while the food product 100 is disposed in the frozen state 200, the first food product portion 12, the second food product portion 14, and the third food product portion 16 are frozen together as a unit. Accordingly, the first food product portion 12, the second food product portion 14 and the third food product portion 16 are each disposed in a frozen condition and disposed in a stacked configuration wherein the first food product portion 12, the second food product portion 14 and the third food product portion 16 are frozen together such that, while the food product 100 is disposed in the frozen state 200, the food product 100 is a solid, frozen unit such that there is an absence of movement between each of the first food product portion 12, the second food product portion 14 and the third food product portion 16, relative to one another. Therefore, it will be understood that while the food product 100 is disposed in the frozen state 200, the first food product portion 12, the second food product portion 14 and the third food product portion 16 are not intended to be easily separable from each other.

With reference, in particular, to FIGS. 2, 4 and 5, while the food product 100 is disposed in the frozen state 200, the first food product portion 12 serves as the base layer or bottom layer of the food product 100. More specifically, in some embodiments, for example, while the food product 100 is in the frozen state 200 and is disposed within a suitable cookware component for re-heating via conduction, the food product 100 is disposed in the heat-receiving orientation 20, wherein the first food product portion 12 is the base or bottom layer of the frozen food product 100 such that the first food product portion 12 is disposed in contact with the base or bottom surface of the cookware component. Accordingly, while the food product 100 is disposed in the heat-receiving orientation 20, the first food product portion 12 is disposed for receiving heat, via conductive heat transfer, from the corresponding heat source through at least the bottom surface of the cookware component in which the food product 100 is emplaced. Accordingly, the first food product portion 12 will be the first portion, or layer, of the food product 100 to begin to thaw and re-heat. The thawing and re-heating of the first food product portion 12 of the food product 100 is with effect that the first food product portion 12 begins to transition from a solid state to a liquid state such that the overall food product 100 begins to transition from the frozen state 200 to the re-heated state that is suitable for consumption by the user.

In example embodiments wherein the first food product portion 12 includes frozen soup broth, the second food product portion 14 includes a frozen noodle mass, and the third food product portion 16 includes at least one or more frozen food ingredients often found as toppings associated with Ramen soup, while the frozen food product 100 is disposed in the heat-receiving orientation 20 and is disposed within a cookware component that is in contact with a heat source, the first food product 12, i.e. the frozen soup broth, will be the first layer of the food product 100 that will absorb heat with effect that the first food product portion 12 will begin to melt, thaw and re-heat. As the first food product portion 12 begins to thaw and melt, heat will begin to be transferred to the second food product portion 14 with effect that the second food product portion 14 begins to thaw and re-heat. As the first food product portion 12 and the second food product portion 14 thaw, and re-heat, the structural integrity of the frozen second food product portion or layer 14 will be compromised and the second food product portion 14 will, eventually, collapse into and become submerged within the melted soup broth that once made up the first food product portion 12 of the frozen food product 100. When the second food product potion 14 is a frozen noodle mass, as in the case of frozen Ramen, as the noodles become submerged within the soup broth that is now disposed in a liquid state, the cooking process of the thawed noodle mass is allowed to complete such that the noodles become disposed in a fully-cooked state and ready for consumption within the re-heated soup broth. Similarly, with the melting and thawing of the first food product portion 12 and the second food product portion 14, heat is transferred to the third food product portion 16, which also undergoes a thawing and/or de-frosting process as the second food product portion 14 transitions to an unfrozen state and the third food product portion 16 contacts the first food product portion 12 that is now in the liquid state. With the collapsing of the second food product portion 14 into the melted first food product portion 12, the individual components or food ingredients that make-up the third food product portion 16, that were originally stacked upon and frozen to an upper surface of the second food product portion 14, will also eventually become disposed within the warming liquid that once made up the first food product portion 12 of the frozen food product 100. Once the first food product portion 12, the second food product portion 14, and the third food product portion 16 have thawed, with the second food product portion 14 and the third food product portion 16 immersed within the re-heated, liquid soup broth that once made up of the frozen first food product portion 12, continued heating of the first, second and third food product portions 12, 14, 16 completes the cooking process of the second food product portion 14 and the third food product portion 16 until the food product 100 is ready to be consumed by the user in a fully re-heated state.

With reference, again to FIGS. 1, 2, 4 and 5, while the food product 100 is disposed in the frozen state 200, the first frozen food product portion 12 has a first surface 22, and a second surface 24 that is disposed opposite to the first surface 22. In some embodiments, for example, the first surface 22 serves as the bottom surface of the food product 100 while the food product 100 is disposed in the frozen state 200 and is disposed in the heat-receiving orientation 20. The second surface 24 serves as a food portion-receiving surface on which the second food product portion 14 is stacked.

While the food product 100 is disposed in the frozen state 200, the first food product portion 12 and the second food product portion 14 are co-operatively configured such that the second food product portion 14 has a first surface 26 that is disposed in face-to-face stacking arrangement with the second surface 24 of the first food product portion 12, thereby defining a first food product portion and second food product portion interface 25. A second surface 28 of the second food product portion 14 is disposed opposite to the first surface 26 and serves as food portion-receiving surface that is configured for receiving the third food product portion 16. Accordingly, it will be understood that in example embodiments wherein the third food product portion 16 is comprised of a plurality of individual toppings or ingredients 16, the plurality of individual toppings are positioned on top of the second surface 28 of the second food product portion 14, thereby defining a second food product portion and third food product portion interface 27. Accordingly, in some embodiments, for example, it will be understood that the second food product portion and third food product portion interface 27 is not necessarily a continuous interface across the entire second surface 28 defined by the second food product portion 14.

In the subject example embodiment, the first food product portion 12 is frozen independently of the second food product portion 14 and the third food product portion 16 in a mold 60. In some embodiments, for example, the second food product portion 14 and the third food product portion 16 are frozen together at the same time, while disposed on top of the independently frozen first food product portion 12, in the same mold 60. Accordingly, in such example embodiments, the second food product portion 14 is frozen to the second side 24 of the first food product portion 12, thereby establishing the first food product portion and second food product portion interface 25, while the third food product portion 16 is frozen to the second surface 28 of the second food product portion 14, thereby establishing the second food product portion and third food product portion interface 27. In other embodiments, for example, the second food product portion 14 and the third food product portion 16 are each frozen independently of one another prior to the layered structure of the food product 100 being established. Accordingly, in some embodiments, the first food product portion and the second food product portion interface 25 is established prior to the second food product portion and third food product portion interface 27 being established in instances where the noodle mass is frozen to the second surface of the frozen soup broth, or first food product portion 12, prior to the toppings and other ingredients, i.e. the third food product portion 16, being frozen to the second surface 28 of the second food product portion 14.

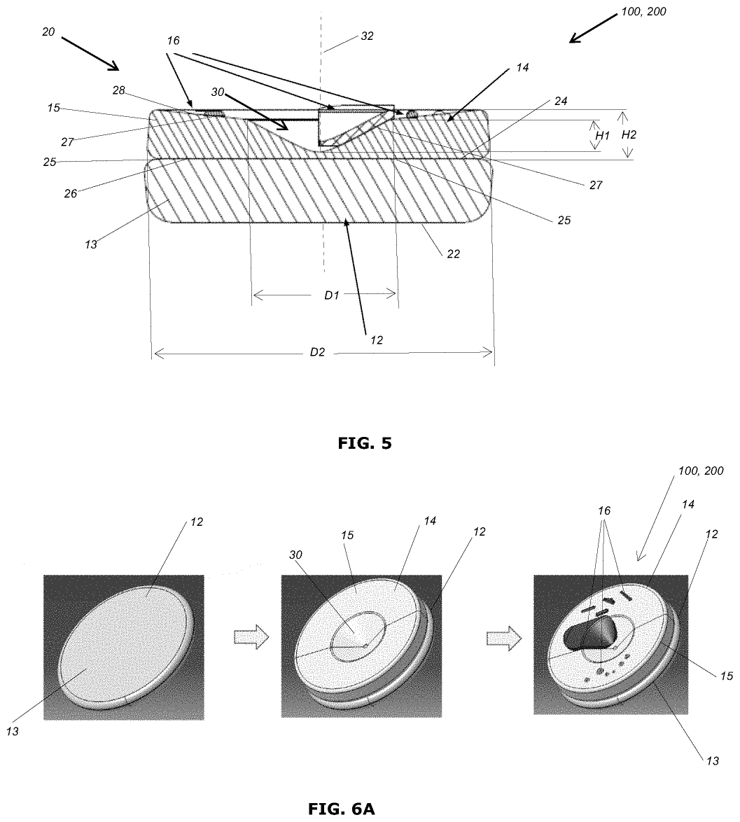

With reference now to FIGS. 2-5, in some embodiments, for example, the second food product portion 14 includes a cavity region 30 that extends into the second food product portion 14 from the second surface 28. The cavity region 30 is a concave area defined within the second food product portion 14 that extends outwardly relative to a central axis 32 that extends vertically through the food product 100, while the food product 100 is disposed within the heat-receiving orientation 20 (see, for instance, FIG. 5). In some embodiments, for example, the cavity region 30 extends radially outwardly from the central axis 32. In some embodiments, for example, the cavity region 30 is conically-shaped.

In some embodiments, for example, the cavity region 30 is configured such that the second surface 28 of the second food product portion 14 includes an annular region 36 that is extends around the cavity region 30, extending from the outermost edge 38 of the cavity region 30 to the outer edge or outer perimeter 40 of the second food product portion 14. In some embodiments, for example, the cavity region 30 is configured such that the cavity region 30 occupies about 5% to about 25% of the surface area defined by the second surface 28 of the second food product portion 14 within the outer edge or outer perimeter 40 of the second food product portion 14. Accordingly, it will be understood that in some embodiments, the first food product portion 12 and the second food product portion 14 are each, generally cylindrical in shape, the second surface 28 of the second food product portion 14 being circular in shape with the cavity region 30 being defined within the second food product portion 14 such that the maximum diameter, D1, defined by the cavity region 30 is less than 50% of the maximum diameter, D2, defined by the second food product portion 14. In some embodiments, for example, the diameter D1 of the cavity region is about ¼ inches to about 1 ½ inches. In some embodiments, for example, the cavity region 30 is configured such that the cavity region 30 has a maximum depth, H1, of about ¼ inches to about ¾ inches of the total height, H2, of the second food product portion 14, as measured along the central axis 32 of the food product 100. In other embodiments, for example, the cavity region 30 extends through the second food product portion 14 such that the depth, H1, of the cavity region 30 is between about a minimum of 50% to a maximum of 100% of the total height, H2, of the second food product portion 14. Accordingly, in some embodiments, for example, the second food product portion 14 includes cavity region 30 such that the second food product portion 14 has a non-uniform thickness. Incorporating a cavity region 30 into the central area of the second food product portion 14 assists with the re-heating of the food product 100 from the frozen state 200 to the re-heated state since the overall thickness and density of the food product 100 is reduced within the central region of the food product 100. As the central area or central region of the food product 100 often takes the longest to re-heat, by reducing the overall thickness of the food product 100 within the central area helps to ensure a more even re-heating process so as to avoid having the portions of the food product 100 disposed at the edges of the food product 100 overcook while waiting for the central region of the food product 100 to thaw and re-heat.

In some embodiments, for example, the cavity region 30 is formed by hand as the noodles 15 that form the second food product portion 14 are disposed on the first food product portion 12. In some embodiments, for example, the cavity region 30 is formed using a male mold portion that is lowered on to the noodle mass that is disposed atop the frozen first food product portion 12 thereby creating the cavity region 30. In some embodiments, for example, the cavity region 30 is maintained prior to the freezing process due to the disposition of one or more toppings that form the third food product portion 16 within the cavity region 30. Once subjected to the freezing process the cavity region 30 is further solidified.

In example embodiments that include a cavity region 30, as shown for example in FIGS. 2, 3 and 5, the third food product portion 16 is disposed on the second food product portion 14 such that at least a portion of the third food product portion 16, or at least some of the toppings or ingredients that make up the third food product portion 16, is disposed within the cavity region 30. As described above, in some embodiments, for example, the third food product portion 16 is comprised of one or more individual ingredients wherein the individual ingredients may differ from each other. In some embodiments, for example, the third food product portion 16 includes various toppings associated with traditional Ramen for example, meat, vegetables, green onions, herbs, seasonings etc. Accordingly, rather than the third food product portion 16 being a unitary layer, the third food product portion 16 is comprised of groupings of various soup toppings or ingredients. For example, in the embodiment illustrated in FIG. 2, the third food product portion 16 includes one or more slices of meat 16a, a grouping of chopped green onions 16b and a grouping of seasoning products 16c, for instance, chopped ginger. However, it will be understood that the third food product portion 16 may be made up of as many different ingredients and/or toppings for a variety of different variations of Ramen.

As described above, when the food product 100 is ready for use, the food product 100 is disposed within any suitable cookware component, in the heat-receiving orientation 20, wherein the first surface 22 of the first food product portion 12 is disposed in contact with the base of cookware component (not shown). As heat is transferred through the cookware component, via conduction, the first food product portion 12 begins to thaw and re-heat. As the first food product portion 12 thaws and re-heats, heat is transferred to the second food product portion 14 with effect that the second food product portion 14 will eventually collapse into the thawed first food product portion 12 that has transitioned from the frozen state to a liquid state. The collapse of the second food product portion 14 into the thawed first food product portion 12 is also with effect that the third food product portion 16 will collapse into the thawed first food product portion 12. Once the second and third food product portions 14, 16 are disposed within the thawed first food product portion 12, continued re-heating of the product 100 completes the cooking and/or re-heating process of the second food product portion 14 and the third food product portion 16 such that the food product 100 is disposed in a fully, re-heated state wherein the food product 100 is suitable for consumption. Accordingly, a single cookware component is required for the re-heating process and the re-heating process is effectively a single-step process that requires heating the food product 100 on, for example, a medium heat setting until the second food product portion 14 and the third food product portion 16 are disposed within the thawed first food product portion 12 at which time the heat can be increased in order to bring the food product 100 to a boil or until the desired temperature and “doneness” for consumption of the food product is reached.

Referring now to the FIGS. 7-10, there is shown another example embodiment of a food product 100 according to the present disclosure wherein the food product 100 is particularly suited for re-heating via radiation, for example, in a microwave oven, or other equivalent device. In the subject example embodiment, the food product 100 comes packaged in a container 50 that is suitable for use within a microwave oven. Accordingly, in some embodiments, for example, the food product 100 is provided within a suitable re-heating container 50, the container 50 and food product 100, together, being vacuum packaged in an outer package or other suitable wrapping.

In the subject example embodiment, while the food product 100 is disposed in the frozen state 200, the first food product portion 12, the second food product portion 14, and the third food product portion 16 are co-operatively configured such that the second food product portion 14 is disposed intermediate the first food product portion 12 and the third food product portion 16, with the food product 100 being disposed within the container such that the first food product portion 14 serves as the base of the food product 100. As in the previously described embodiment, in the subject example embodiment, the first food product portion 12, the second food product portion 14, and the third food product portion 16 are also frozen together as a unit. However, in the subject example embodiment, the frozen unit is disposed within a container 50 that is suitable for use in re-heating the food product 100 within a microwave oven.

As in the previously described embodiment, while the food product 100 is disposed in the frozen state 200, the first food product portion 12 and the second food product portion 14 are co-operatively configured such that the second food product portion 14 has a first surface 26 that is disposed in face-to-face stacking arrangement with the second surface 24 of the first food product portion 12, thereby defining a first food product portion and second food product portion interface 25. A second surface 28 of the second food product portion 14 is disposed opposite to the first surface 26 and serves as food portion-receiving surface that is configured for receiving the third food product portion 16.

In the subject example embodiment, the first food product portion 12 is frozen independently of the second food product portion 14 and the third food product portion 16. More specifically, in example embodiments wherein the food product 100 is a frozen soup product, such as frozen Ramen, the first food product portion 12 is soup broth that is disposed within the container base 50 and frozen, thereby establishing the first food product portion 12, the container base, thereby serving as a mold. Once the first food product portion 12 (i.e. the soup broth) is disposed in the frozen state, the second food product portion 14 is disposed on the second, food product-receiving surface 24 of the first food product portion 12 and frozen, thereby establishing the first food product portion and second food product portion interface 25. As in the previously described embodiment, in the subject example embodiment, the second food product portion 14 is a frozen noodle mass that is frozen to the top surface 24 of the frozen soup broth base.

In the subject example embodiment, the second food product portion 14 is configured such that the second food product portion 14 has a generally uniform or continuous thickness across the diameter of the second food product portion 14. Accordingly, unlike the previously described food product 100 that is particularly suited for re-heating, via conduction, in the subject example embodiment, the second food product portion 14 does not include a cavity region 30 disposed within the central area of the second food product portion 14.

With reference, in particular to FIG. 9, in the subject example embodiment, the third food product portion 16 is frozen separately to the first food product portion 12 and the second food product portion 14, in a separate mold (not shown). In the subject example embodiment, the third food product portion 16 is a frozen layer that includes one or more frozen ingredients 16(1) that are encased, or at least partially encased, within a second portion of frozen soup broth 16(2). In some embodiments, for example, the second portion of frozen soup broth 16(2) has a volume that is less than the volume of the portion of soup broth that forms the first food product portion 12. Accordingly, rather than stacking or layering the one or more ingredients or toppings, that are commonly found in traditional Ramen, directly on the food product-receiving surface 28 defined by the second food product portion 14, the one or more ingredients or toppings 16(1) are disposed within a second portion of soup broth 16(2), the second portion of soup broth 16(2) and the one or more ingredients or toppings 16(1) being frozen together such that the one or more ingredients or toppings 16(1) are embedded or encased, or at least partially embedded or partially encased, within the second portion of soup broth 16(2). Therefore, in the subject example embodiment, the third food product portion 16 is a composite layer that includes both individual frozen food products (or toppings or ingredients) 16(1) and frozen soup broth 16(2). Accordingly, in some embodiments, for example, the food product 100 is a frozen food product comprising a first food product portion 12, a second food product portion 14 and a third food product portion 16, wherein the first food product portion 12, the second food product portion 14 and the third food product portion 16 are cooperatively configured such that the second food product portion 14 is disposed intermediate the first food product portion 12 and the third food product portion 16, and the first food product portion 12 is a first portion of frozen soup broth 13, the second food product portion 14 is a frozen noodle mass 15; and the third food product portion 16 includes a second portion of frozen soup broth 16(2) and a plurality of frozen food items 16(1) embedded within (or at least partially embedded within) the second portion of frozen soup broth 16(2).

Once the one or more ingredients or toppings 16(1) and second portion of soup broth 16(2) and frozen together establishing the third food product portion 16, the third food product portion 16 is removed from its corresponding mold and is disposed on top of the second food product portion 14, within the container 50, thereby establishing the second food product portion and third food product portion interface 27.

Accordingly, in some embodiments, the second food product portion 14 is frozen to the second side 24 of the first food product portion 12 establishing the first food product portion and second food product portion interface 25 prior to the third food product portion 16 being frozen to the second surface 28 of the second food product portion 14 establishing the second food product portion and third food product portion interface 27. Specifically, in the example embodiment of FIGS. 7-10, the second food product portion 14 and the third food product portion 16 are frozen independently of one another, prior to the layered structure of the food product 100 being established. Therefore, in some example embodiments, the first food product portion and the second food product portion interface 25 is established prior to the second food product portion and third food product portion interface 27 being established. In the example embodiment illustrated in FIG. 9, once the third food product portion 16 is disposed on the second food product portion 14, the food product 100, together with the container 50, are sealed within outer packaging and suitable for storage within a freezer until the food product 100 is ready for use.

When the food product 100 according to the example embodiment of FIGS. 7-10 is ready for use, the food product 100 with container 50 is removed from the outer packaging and the container 50, with the food product 100 contained therein, is disposed within a microwave oven for re-heating. Unlike re-heating, via conduction on a stove-top, wherein in heat is transferred in one direction through the base of the product, microwave ovens use short, high-frequency waves that penetrate the food product 100 from all directions. The short, high-frequency waves agitate water molecules contained within the food product 100 to create friction, which transfers heat to the food product 100. As the short, high-frequency waves from the microwave oven penetrate the frozen food product 100 from all directions, in the subject example embodiment, each of the first food product portion 12, the second food product portion 14 and the third food product portion 16, will begin warming at the same time. Due to the higher moisture content of the first food product portion 12 and the third food product portion 16 (which includes both solid foods and frozen soup broth), the first food product portion 14 and the third food product portion 16 may begin to warm faster than the second food product portion 14. As the soup broth 13 that makes up the first food product portion 12 begins to thaw, the second food product portion 14 will begin to collapse into the thawing soup broth. Similarly, as the soup broth 16(2) that forms part of the third food product portion 16 begins to thaw, the soup broth 16(2) from the third food product portion 16 will melt over the top of the second food product portion 14 and further assist with the thawing of the second food product portion 14. By having warming soup broth, or liquid, contact the second food product portion 14 from both the bottom or first 26 surface of the second food product portion 14, i.e. at the interface 25 between the first food product portion and the second food product portion 14, as well as from the top or second, food product-receiving surface 28 of the second food product portion 14, i.e. at the interface 27 of the second food product portion 14 and the third food product portion 16, the second food product portion 14 is subjected to a more even warming process which helps to prevent and/or mitigate against the potential for over-cooking or drying-out of the noodles 15 that form the second food product portion 14 prior to the second food product portion 14 becoming submerged within the thawed soup broth from both the first food product portion 12 and the third food product portion 16, that has transitioned from the frozen state to the liquid state.

While the above-described example embodiment has been described in connection with a food product 100 that is disposed within a container 50 and is particularly suited for re-heating via a microwave oven, it will be understood that the above-described embodiment, may also be prepared as a standalone food product 100 that does not include a separate container 50 for storing and re-heating the frozen food product 100. Therefore, in some embodiments, for example as shown in FIG. 11, the frozen food product 100 that is suitable for re-heating, via conduction, on a conventional stove-top or other suitable heat source once the frozen food product 100 is removed from an outer wrapping and placed within a suitable cookware component, includes: (i) a first food product portion 14 comprised of frozen soup broth, (ii) a second food product portion 14 comprised of a frozen noodle mass 15 having a generally, planar second or top surface 26, and (iii) a third food product portion 16 comprised of a composite layer made up of a second portion 16(2) of soup broth and one or more individual toppings or ingredients, 16(1), that are encased or embedded, or at least partially encased or embedded, in the frozen second portion 16(2) of soup broth 16(2).

Re-heating of the frozen food product 100 illustrated in FIG. 11, is achieved in a similar manner as described in connection with the embodiment illustrated in FIGS. 1-6. More specifically, heat is conducted through the surface in contact with the first or base surface 21 of the first food product portion 12. As the first food product portion 12 begins to melt and thaw, heat is transferred to the second food product portion 14 causing the second food product portion 14 to collapse into the thawing first food product portion 12. As the second food product portion 14 begins to thaw, the second food product portion 14 transfers heat to the third food product portion 16, causing the second portion of broth 16(2) to begin to thaw and melt transferring heat to the encased or embedded ingredients or toppings 16(1). The melting second portion of broth 16(2) also causes soup broth to melt over the top surface 28 of the second food product portion 14 which may assist with ensuring more even cooking of the frozen noodle mass 15. Ambient heat that circulates within the cookware component can also assist with causing the third food product portion 16 to thaw, melt.

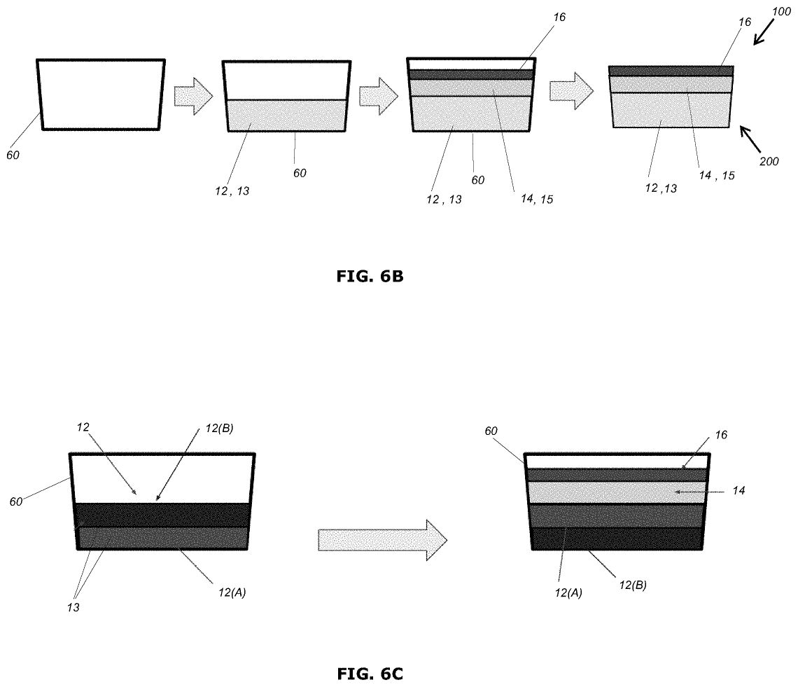

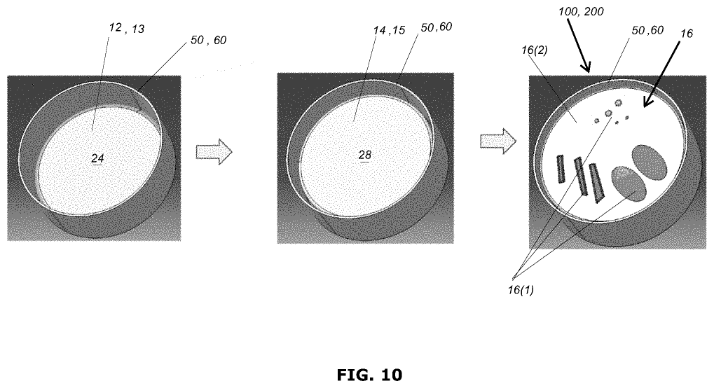

A method of making the food product 100 according to example embodiments of the present disclosure will be described in further detail below with reference, in particular to FIGS. 6A-6C and FIG. 10.

As described above, in some embodiments, for example, the food product 100 is a frozen soup product such as frozen Ramen. In such example embodiments, the soup broth, which serves as the first food product portion 12, is prepared according to any suitable method known in the art. In some embodiments, for example, the first food product portion 12 is soup broth that includes tare. In some embodiments, for example, the soup broth and tare are boiled together with additional vegetables, which the vegetables are then removed from the soup and tare mixture, after partial cooking, for use as toppings or food item ingredients for the finished soup product. In some embodiments, the soup broth is made in a batch that includes 24 individual servings of soup. However, it will be understood that the batches of soup broth can be made to include more than 24 individual servings or less than 24 servings, depending on the required number of servings of individual soup that are required.

Once the soup broth is prepared and has been cooled to about room temperature, a serving of soup broth is disposed in a mold 60. The mold 60, together with the serving of soup broth, is disposed in a freezer for freezing of the soup broth such that the soup broth is disposed in a frozen state, thereby forming the first food product portion 12. In some embodiments, for example, the first food product portion 12, is frozen to a temperature of at least −20 degrees Celsius. In some embodiments, for example, the first food product portion 12 is frozen to a temperature of at least −40 degrees Celsius. In some embodiments, for example, the first food product portion 12 is frozen to a temperature no colder than −60 degrees Celsius.

In some embodiments, for example, the freezing of the first food product potion 12 is for a period of at least 8 hours.

Once the first food product potion 12 is disposed in the frozen state, the mold 60 is removed from the freezer in order to receive at least the second food product portion 14, before being returned to the freezer, as will be described in further detail below.

In order to form the second food product portion 14, which is comprised of a frozen noodle mass 15, the noodles are first disposed in boiling water and are boiled for only a portion of the total, predetermined cooking time for the particular type of noodle that is being prepared. In some embodiments, for example, the noodles are cooked for less than 50% of the total, predetermined cooking time for the particular noodle type. In some embodiments, for example, the noodles are cooked, between a minimum of greater than 1/7^{th} of the total, predetermined cooking time for the particular noodle type to a maximum of no more than ½ of the total, predetermined cooking time for the particular noodle type. In some embodiments, for example, the noodles are cooked, between a minimum of at least ⅙^{th} of the total, predetermined cooking time for the particular noodle type to a maximum of no greater than ⅕^{th} of the total, predetermined cooking time for the particular noodle type.

Once the noodles have been partially cooked, via boiling, the noodles are removed from the boiling water and quenched in a cold water bath. In some embodiments, for example, the cold water bath is at a temperature between about a minimum of 6 degrees Celsius to a maximum of 15 degrees Celsius. In some embodiments, for example, the noodles are quenched in the cold water bath for a period of time such that the noodles achieve thermal equilibrium with the water bath. In some embodiments, for example, the noodles are quenched in the cold water bath for a period of at least 45 seconds to a maximum of 60 seconds. Quenching the partially cooked noodles within a cold water bath has been found to halt the cooking process to ensure that the noodles maintain a desired firmness for tolerating the freezing process, and to maintain the integrity of the noodles in the re-heated food product 100. Quenching the partially cooked noodles within a cold water bath has also been found to remove any excess flour that may have remained on the surface of the noodles. Excess flour is often found on the surface of raw, uncooked noodles as excess flour has been found to maintain the quality of the uncooked, raw noodles while they are being stored and/or transported. The excess flour on the surface of the noodles helps to keep the noodles from sticking together and also helps to keep the noodles dry. Removal of any excess flour from the outer surface of the noodles, prior to serving, is important as any excess flour remaining on the outer surface of the noodle may contribute to the noodles having a sandy or gritty texture, which is considered undesirable in a finished Ramen product.

Once the quenching process is complete, the noodles are removed from the cold water bath using a strainer (or any other suitable means) and are allowed to dry. The drying process is with effect that excess moisture is removed from the partially cooked noodles. In some embodiments, for example, excess water is removed from the partially cooked noodles using a food spinner wherein centrifugal forces separate excess water from the noodles, thereby drying the noodles. Once the noodles have been dried, for example, in a food spinner, the noodles are tossed with oil. In some embodiments, for example, the oil used is selected from one of the following alternatives: pork back fat, chicken oil, yuzu oil, flavoured oil, chili oil or fish oil. In some embodiments, for example, the noodles are tossed with the oil, via hand-mixing. In some embodiments, for example, the noodles are hand-mixed with oil using a generally circular, folding motion bringing noodles from the bottom of the strainer (or any other suitable container) towards the top of the noodle mass until the noodles gain an all-over shiny, oily appearance. In example embodiments wherein a solid fat is used as the oil product (e.g. pork back fat), the noodles are mixed with the solid fat (e.g. pork back fat) until there are no lumps or clumps of solid fat (e.g. pork back fat) remaining amongst the noodles and the noodles have an all-over glossy or shiny appearance.

Once the noodles have been uniformly coated in the oil, the noodles are divided into portions that correspond to the portion of soup broth that has been frozen as the first food product portion 12 within the mold 60. The mold 60 that contains the frozen first food product portion 12 is removed from the freezer and the corresponding serving of oil-coated, partially cooked noodles 15 are disposed on the second or food product-receiving surface 24 of the first food product portion 12, the oil-coated noodles thereby forming the second food product portion 14. Once the oil-coated, partially cooked noodles 15 are disposed on the food product-receiving surface 24 of the first food product portion 12, the noodles 15 are arranged on the first food product portion 12 such that the cavity region 30 is formed within the central area of the mass of oil-coated, partially cooked noodles 15. See for instance FIG. 6A. As described above, in some embodiments, for example, the cavity region is formed by hand. In other embodiments, for example, the cavity region 30 is formed using a male mold portion that is lowered into the noodle mass creating the cavity region 30. The male mold portion is then removed and the cavity region 30 is maintained as one or more of the toppings that form the third food product portion 16 are disposed within the cavity region 30. Freezing of the second food product portion 14 together with the third food product portion 16 solidifies the cavity region 30 within the second food product portion 14.

In some embodiments, for example, once the second food product portion 14 is disposed on the first food product portion 12 and the cavity region 30 is arranged within the second food product potion 14, the third food product portion 16 is disposed on top of the second food product portion 14 within the mold 60 such that at least a portion of the third food product potion 16 is disposed within the cavity region 30. In example embodiments wherein the third food product portion 16 includes a plurality of individual ingredients or toppings, such as meat and vegetables, for example, the individual ingredients are at least partially cooked prior to being positioned on the second food product portion 14. When the third food product portion 16 includes meat, the meat is fully cooked to the required doneness, as is known in the art, prior to being positioned on top of the second food product portion 14. In the case of vegetables, the vegetables are partially cooked and quenched in a cold bath prior to being positioned on top of the second food product portion. In some embodiments, for example, the vegetables are cooked in boiling water, or via any suitable means, for about 3-15 seconds of the total, predetermined cooking time prior to quenching and positioning on the second food product portion 14. In some embodiments, for example, when the third food product portion 16 includes a plurality of individual ingredients or toppings, such as meat and vegetables, for example, the portion of the third food product portion 16 that is disposed within the cavity region 30 includes the at least the meat. See for instance FIG. 6A.

Once the second and third food product portions 14, 16 are disposed within the mold 60 in their layered relationship, the mold 60 is returned to the freezer with effect that the second food product portion 14 and the third food product portion 16 become disposed in the frozen state 200. In some embodiments, for example, the second food product portion 14 and the third food product portion 16 are frozen to a temperature of at least −20 degrees Celsius. In some embodiments, for example, the second food product portion 14 and the third food product portion 16 are frozen to a temperature of at least −40 degrees Celsius.

In some embodiments, for example, the second food product portion 14 and the third food product portion 16 are frozen to a temperature of at least −60 degrees Celsius. In some embodiments, for example, the freezing of the second and third food product portions 14, 16 is for a period of at least 8 hours.

Once the second food product portion 14 and the third food product portion 16 become disposed in the frozen state 200, the mold 60 is removed from the freezer and the first food product portion 12, the second food product portion 14 and the third food product portion 16 are removed from the mold 60 as a frozen unit, with effect that the frozen food product 100 is released from the mold 60. See for instance, FIG. 6B. Once the frozen food product 100 is removed from the mold 60, the food product 100 is packaged in any suitable outer packaging or outer wrapping for storing and/or delivery to a customer. In some embodiments, for example, the food product 100 is vacuum packaged. Once the food product 100 is packaged in the outer wrapping or packaging, the food product 100 can be stored in a freezer until the food product 100 is ready for use.

As described above, in some embodiments, for example, first food product portion 12, the second food product portion 14 and the third food product portion 16 are each frozen to a temperature of at least −60 degrees Celsius. In some embodiments, freezing of the soup broth, the noodles and the toppings to at least −60 degrees Celsius has been found to maintain the quality and freshness of the respective food product portions. More specifically, in the case of the soup broth 13, freezing the soup broth 13 to at least −60 degrees Celsius has been found to freeze the soup broth 13 quickly such that the cellular structure within the soup broth 13 is retained. In the case of the noodles 15, it has been found that freezing the noodles to a temperature of less than −20 degrees Celsius, such as at least −60 degrees Celsius, allows the noodles 15 to freeze quickly which prevents the partially cooked oil-coated noodles 15 from absorbing additional moisture, which can alter the overall texture of the noodles 15 upon re-heating. In particular, the absorption of additional liquid can cause the noodles 15 to stretch or have a softer, overcooked texture upon re-heating. In the case of the individual toppings, it has been found that freezing of the toppings to a temperature that is colder than −20 degrees Celsius, such as at least −60 degrees Celsius, maintains the quality of the individual toppings upon the re-heating of the product. In particular, in the case of meat toppings, the freezing process to a temperature that is colder than −20 degrees Celsius, such as at least −60 degrees Celsius, has been found to maintain the quality of meat as moisture is retained within the meat during the freezing process which results in meat that has a more enjoyable texture and that is not dried-out upon re-heating.

Referring now to FIG. 6C, in some embodiments, for example, while the first food product portion 12 undergoes the freezing process, the first food product portion 12 freezes such that the composition of a bottom or first portion 12(A) of the first food product portion 12 is different than an upper or second portion 12(B) of the first food product portion 12. More specifically, in example embodiments wherein the food product 100 is a Ramen product and the first food product portion 12 is soup broth, in some instances, the soup broth 13 freezes such that the bottom or first portion 12(A) of the first food product portion 12 contains a higher concentration of salt while the upper or second portion 12(B) of the first food product portion 12 has a lower salt concentration, relative to the bottom portion 12(A) of the frozen first food product portion 12. When the partially cooked noodles are disposed on the frozen first food product portion 12, in some instances, localized melting of the first food product portion 12 can sometimes occur which may have a tendency to discolour and/or alter the texture of the noodles that are in direct contact with the first frozen food product 12. In order to minimize or mitigate against any discoloration and potential adverse effects to the texture of the noodles that are in direct contact with the first food product portion 12 and, therefore, are more susceptible to absorption of additional moisture at the interface 25 between the partially-cooked, oil-coated noodles 15 and the frozen first food product portion 12, in some embodiments, for example, prior to the noodles 15 being disposed on the frozen first food product portion 12 within the mold 60, the first food product portion 12 is removed from the mold and inverted such that the first portion 12(A) of the first food product portion 12 with the higher salt concentration is disposed at the top of the first food product portion 12, with the second, lower salt concentration portion 12(B) of the first food product portion 12 being disposed at the bottom of the mold 60. Accordingly, in such example embodiments, the first portion 12(A) of the first food product portion 12 that has the higher salt concentration defines the second, or food product-receiving surface 24 of the first food product portion 12. Once the first food product portion 12 is inverted, the partially cooked noodles are disposed on the first food product portion 12 in contact with the higher salt concentration portion 12(A) of the first food product portion 12. The inverting of the frozen first food product portion 12 has been found to minimize the potential adverse effects of localized melting of the first food product portion 12 at the interface between the first food product portion 12 and the second food product portion 14.

Once the first food product portion 12, the second food product portion 14 and the third food product portion 16 are frozen together and removed from the mold, the food product 100 is vacuum packaged. Once the food product 100 is sealed within the outer packaging, the food product 100 can be stored in a suitable freezer unit until the product 100 is ready to be enjoyed.

With regards to the example embodiment illustrated in FIGS. 7-10 that is particularly suited for re-heating in a microwave, the method of making the food product 100 is similar to the method described above with the differences being described in further detail below.

As shown in FIG. 10, in the subject example embodiment, the container 50 that houses the food product 100 and that is suitable for use in a microwave oven for re-heating of the food product 100 also serves as the mold 60 for making the frozen food product 100. Accordingly, as described above, a serving of soup broth 13 is added to the container 50 and the container 50, together with the serving of soup broth 13 is disposed in the freezer for freezing of the soup broth in accordance with the process steps described above in connection with FIGS. 6A and 6B, for forming the frozen first food product portion 12, as shown in FIG. 10. Once the soup broth 13 is frozen to the required temperature, thereby forming the first food product portion 12, in some embodiments, for example, a corresponding serving of the partially-cooked, oil-coated noodles 15 are disposed directly on the food product-receiving surface 24 defined by the first food product portion 12. In other embodiments, for example, once the soup broth 13 is frozen thereby forming the first food product portion 12, the first food product portion 12 is removed from the container 50, inverted, and returned to the container 50 prior to the serving of partially-cooked, oil-coated noodles 15 being disposed on the first food product portion 12 such that the first portion 12(A) of the first food product portion 12 defines the food product-receiving surface 24 for receiving the serving of partially-cooked, oil-coated noodles 15.

In the subject example embodiment, once the oil-coated partially cooked noodles 15 are disposed on the food product-receiving surface 24 defined by the first food product portion 12, the container 50 is returned to the freezer where the oil-coated, partially-cooked noodles 15 are frozen to a temperature of less than −20 degrees Celsius, for example to a temperature of at least −60 degrees Celsius, for forming the second food product portion 14.

In the subject example embodiment, the third food product portion 16 is a frozen layer that includes one or more frozen ingredients 16(1) that are encased within a second portion of frozen soup broth 16(2). The third food product portion 16 is formed separately from the first food product portion 12 and the second food product portion 14 in a separate mold (not shown). Accordingly, the soup broth 16(2) and the plurality of individual food products 16(1) are frozen together in a separate mold such that the plurality of individual food products 16(1) become encased or embedded within frozen soup broth 16(2). The soup broth and the plurality of individual food products are frozen under the same conditions as described in connection with the previous embodiments, and is frozen to a temperature of less than −20 degrees Celsius, for example to a temperature of at least −60 degrees Celsius, thereby forming the third food product portion 16. In some embodiments, for example, the combined soup broth with the plurality of individual food products are frozen to a temperature of at least −60 degrees Celsius for at least a period of 8 hours. Once the frozen third food product portion 16 is formed, the third food product portion 16 is removed from the corresponding mold and is disposed on second, or food product-receiving surface 28 of the second food product portion 14 within the container 50, the food product 100 is vacuum packaged in an outer wrapping and labelled accordingly and stored in a freezer until the food product 100 is ready for use. Accordingly, it will be understood that, in some embodiments, the second food product 14 is frozen and formed separately to the third food product portion 16. With regard to the example embodiment illustrated in FIG. 11, it will be understood that the method of making the frozen food product 100 is the same except for that the first food portion 12 and the second food portion 14 are frozen in a mold 60, rather than a microwaveable container, while the third food product portion 16 is frozen in a separate mold. Once the third food product portion 16 is frozen it is removed from the corresponding mold and disposed on top of the frozen second food product portion 14 within the mold 60, with the mold being returned to the freezer such that the third food product portion 16 freezes to the second food product portion 14, the food product 100 thereby forming a frozen unit. Once frozen as a unit, the food product 100 is removed from the corresponding mold 60 and wrapped in appropriate packaging. Once the wrapped in the appropriate packaging, the food f=product 100 can be stored in a freezer until such time that a user wishes to consume the product.

While various example embodiments of frozen food products and the methods of manufacturing the same have been described, it will be understood that certain adaptations and modifications of the described embodiments can be made. Therefore, the above discussed embodiments are considered to be illustrative and not restrictive.

1. A frozen food product, comprising:
a first food product portion;
a second food product portion; and
a third food product portion;
wherein:
the first food product portion is frozen soup broth;
the second food product portion is a frozen noodle mass; and
the third food product portion includes at least one or more individual frozen food items;
and
the first food product portion, the second food product portion and the third food product portion are cooperatively configured such that:
the first food product portion, the second food product portion and the third food product portion are a frozen unit; and
the second food product portion is disposed intermediate the first food product portion and the third food product portion.

2. The frozen food product as claimed in claim 1;
wherein:
the frozen food product is frozen Ramen.

3. The frozen food product as claimed in claim 1;
wherein:
the frozen food product has a heat-receiving orientation; and
while the frozen food product is disposed in the heat-receiving orientation, the first food product portion is a base of the frozen food product.

4. The frozen food product as claimed in claim 1;
wherein:
the frozen noodle mass comprises noodles that are partially cooked and coated in oil prior to freezing; and
the noodles are selected from one of the following alternatives: Ramen noodles, egg noodles, rice noodles, buckwheat noodles, or udon noodles.

5. The frozen food product as claimed in claim 4;
wherein:
the oil for coating the partially cooked noodles is selected from one of the following alternatives: pork back fat, chicken oil, yuzu oil, flavoured oil, chili oil or fish oil.

6. The frozen food product as claimed in claim 4;
wherein:
the noodles have a predetermined cooking time; and
the partial cooking of the noodles is such that the noodles are partially cooked, via boiling, for a minimum of ⅙^{th} of the predetermined cooking time to a maximum of ⅕^{th} of the predetermined cooling time.

7. The frozen food product as claimed in claim 1;
wherein:
the first food product portion has a food product-receiving surface;
the second frozen food portion has a first surface disposed in contact with the food product-receiving surface of the first food product portion, and a second surface, disposed opposite to the first surface;
the second food product portion includes a cavity region that extends into the second food product portion from the second surface; and
the third food product portion is disposed on the second food product portion such that at least a portion of the third food product portion is disposed within the cavity region.

8. The frozen food product as claimed in claim 7;
wherein:
the cavity region extends radially outwardly from a central axis that extends vertically through the frozen food product while the frozen food product is disposed in the heat-receiving orientation; and
the cavity region extends into the second food product portion such that the cavity region has a maximum depth, as measured along the central axis, of at least 50% to a maximum of 100% of the maximum height of the second food product portion, as measured along the central axis.

9. The frozen food product as claimed in claim 8;
wherein:
the cavity region is conically-shaped.

10. The frozen food product as claimed in claim 1;
wherein:
the third food product portion includes one or more individual food items selected from one or more of the following alternatives: meat, vegetable-based protein sources, vegetables, fungi, herbs, and seasonings.

11. The frozen food product as claimed in claim 1;
wherein:
the frozen food product is suitable for re-heating via conduction.

12. A frozen food product, comprising:
a first frozen food portion defining a first surface and second, food product-defining surface that is disposed opposite to the first surface;
a second frozen food portion defining a first surface and a second food product-defining surface, disposed opposite to the first surface; and
a third frozen food portion;
wherein:
the second frozen food portion includes a cavity region that extends into the second frozen food portion from the second, food product-defining surface;
the third frozen food portion includes one or more individual frozen food items;
and
the first frozen food portion, the second frozen food portion and the third frozen food portion are cooperatively configured such that:
the second frozen food portion is disposed intermediate the first frozen food and the third frozen food portion; and
the third frozen food portion is disposed on the second frozen food portion such that at least one of the one or more individual frozen food items is disposed within the cavity region.

13. The frozen food product as claimed in claim 12;
wherein:
the first frozen food portion includes frozen soup broth;
the second frozen food portion includes a frozen noodle mass; and
the third frozen food portion includes at least one or more individual frozen food items selected from one or more of the following alternatives: meat, vegetable-based protein sources, vegetables, herbs, and seasonings.

14. The frozen food product as claimed in claim 13;
wherein:
the cavity region is conically-shaped and extends into the second food product portion such that the cavity region has a maximum depth, as measured along a central axis that extends vertically through frozen food product, while the frozen food product is disposed in a heat-receiving orientation, of at least 50% to a maximum of 100% of the height of the second food product portion, as measured along the central axis.

15. The frozen food product as claimed claim 12;
wherein:
the frozen noodle mass comprises noodles that are partially cooked and coated in oil prior to freezing;
the noodles are selected from one of the following alternatives: Ramen noodles, egg noodles, rice noodles, buckwheat noodles, or udon noodles; and
the oil for coating the partially cooked noodles is selected from one of the following alternatives: pork back fat, chicken oil, yuzu oil, flavoured oil, chili oil or fish oil.

16. (canceled)

17. The frozen food product as claimed in claim 15;
wherein:
the noodles have a predetermined cooking time; and
the partial cooking of the noodles is such that the noodles are partially cooked, via boiling, for a minimum of ⅙^{th} to a maximum of ⅕^{th} of the predetermined cooling time.

18. A frozen food product, comprising:
a first food product portion;
a second food product portion; and
a third food product portion;
wherein:
the first food product portion, the second food product portion and the third food product portion are cooperatively configured such that:
the second food product portion is disposed intermediate the first food product portion and the third food product portion;
and
the first food product portion is a first portion of frozen soup broth;
the second food product portion is a frozen noodle mass; and
the third food product portion includes a second portion of frozen soup broth and a plurality of frozen food items at least partially embedded within the second portion of frozen soup broth.

19. The frozen food product as claimed in claim 18;
wherein:
frozen food product is frozen Ramen.

20. The frozen food product as claimed in claim 18;
wherein:
the frozen noodle mass comprises noodles having a predetermined cooking time that are partially cooked, via boiling, for a minimum of ⅙^{th} of the predetermined cooking time to a maximum of ⅕^{th} of the predetermined cooling time, the partially cooked noodles further comprising a coating of oil prior to freezing;
the noodles are selected from one of the following alternatives: Ramen noodles, egg noodles, rice noodles, buckwheat noodles, or udon noodles; and
the oil for coating the partially cooked noodles is selected from one of the following alternatives: pork back fat, chicken oil, yuzu oil, flavoured oil, chili oil or fish oil.

21. (canceled)

22. (canceled)

23. The frozen food product as claimed in claim 18;
wherein:
the third food product portion includes one or more individual food products selected from one or more of the following alternatives: meat, vegetable-based protein sources, vegetables, fungi, herbs, and seasonings.

24.-40. (canceled)
